(19) United States
(12) Patent Application Publication
(10) Pub. No.: US 2026/0008111 A1
(43) Pub. Date: Jan. 8, 2026

(54) ROTARY TOOL

(71) Applicant: Kennametal Inc., Latrobe, PA (US)

(72) Inventors: Stephen M George, Greensboro, NC (US); Danny R Davis, Asheboro, NC (US)

(21) Appl. No.: 18/763,595

(22) Filed: Jul. 3, 2024

(51) Int. Cl. B23C 5/10

(52) U.S. Cl. CPC B23C 5/10

(57) ABSTRACT

The present invention provides a rotary tool having a plurality of main flutes extending helically about the longitudinal axis and a plurality of sets of auxiliary flutes that extend helically opposite hand from the main flutes about the longitudinal axis, wherein the sets of auxiliary flutes comprise a first auxiliary flute closer along the longitudinal axis to the shank end and a final auxiliary flute closer along the longitudinal axis to the front end that each intersect the main flutes to form a plurality of cutting units having a first cutting edge facing the direction of rotation along the main flute and a second cutting edge facing the direction of rotation along the auxiliary flute. Also disclosed are methods of making the rotary tool and methods of milling a substrate using the rotary tool.

### FIELD OF THE INVENTION

The present invention relates to a rotary tool, methods of manufacturing rotary tools, and methods of milling a substrate using the rotary tool.

### BACKGROUND INFORMATION

The present invention is directed to a rotary tool that is used for milling a substrate. These rotary tool may have main cutting flutes with auxiliary flutes included for the evacuation of chips from the substrate being cut during cutting. These auxiliary flutes result in an interrupted nature of the cutting edge. The interrupted nature of the cutting edge can lead to localized accumulated chip load resulting from multiple main cutting flutes passing a localized area without cutting the substrate surface. The accumulated chip load results in excess stress to a cutting edge that eventually cuts the localized area after several main cutting flutes passed it over. The excess stress can result in damage to the cutting surface, such as chipping of the cutting surface of the rotary tool.

### SUMMARY OF THE INVENTION

The present invention provides a rotary tool having a longitudinal axis about which the rotary tool is rotatable in a direction of rotation, the rotary tool comprising: a base body extending in a longitudinal direction from a shank end to a front end opposite the shank end, the base body comprising a cutting section comprising a peripheral surface extending from the front end towards the shank end, the peripheral surface of the cutting section comprising: a plurality of main flutes extending helically about the longitudinal axis to define a plurality of helical teeth comprising a leading face, a rear face, and a first cutting edge facing the direction of rotation along the main flute, wherein each of the main flutes is between the rear face and leading face of two adjacent helical teeth, and a plurality of sets of auxiliary flutes, wherein the sets of auxiliary flutes comprise a first auxiliary flute closer along the longitudinal axis to the shank end and a final auxiliary flute closer along the longitudinal axis to the front end that each intersect a helical tooth to form a plurality of cutting units along the helical tooth comprising main cutting units and auxiliary cutting units, wherein the main cutting units comprise a main cutting edge along the first cutting edge of the helical tooth and a second cutting edge facing the direction of rotation along the auxiliary flute, wherein the main cutting edge has a length that extends between two sets of auxiliary flutes measured along the main flute from a first point defined as an intersection of the main flute and a final auxiliary flute and extending towards the front end to a second point defined as an intersection of the main flute and a first auxiliary flute, the second cutting edge has a length that extends between the main flutes measured along the auxiliary flute, and an aspect ratio of the length of the main cutting edge to the length of the second cutting edge is greater than 1:1, wherein the auxiliary cutting units comprise an auxiliary cutting edge along the first cutting edge of the helical tooth and a second cutting edge facing the direction of rotation along the auxiliary flute, wherein the auxiliary cutting edge has a length that extends between two adjacent auxiliary flutes of one set of auxiliary flutes measured along the first cutting edge, the second cutting edge has a length that extends between the main flutes measured along the auxiliary flute, and an aspect ratio of the length of the auxiliary cutting edge to the length of the second cutting edge is less than 1:1, and wherein the main cutting units alternate with one or more auxiliary cutting units along the helical tooth.

The present invention also provides a rotary tool having a longitudinal axis about which the rotary tool is rotatable in a direction of rotation, the rotary tool comprising: a base body extending in a longitudinal direction from a shank end to a front end opposite the shank end, the base body comprising a cutting section comprising a peripheral surface extending from the front end towards the shank end, the peripheral surface of the cutting section comprising: a plurality of main flutes extending helically about the longitudinal axis and a plurality of sets of auxiliary flutes that extend helically opposite hand from the main flutes about the longitudinal axis, wherein the sets of auxiliary flutes comprise a first auxiliary flute closer along the longitudinal axis to the shank end and a final auxiliary flute closer along the longitudinal axis to the front end that each intersect the main flutes to form a plurality of cutting units having a first cutting edge facing the direction of rotation along the main flute and a second cutting edge facing the direction of rotation along the auxiliary flute, wherein the first cutting edge of the cutting units formed along the main flute comprises a main cutting edge and an auxiliary cutting edge, wherein the main cutting edge has a length that extends between two sets of auxiliary flutes measured along the main flute from a first point defined as an intersection of the main flute and a final auxiliary flute and extending towards the front end to a second point defined as an intersection of the main flute and a first auxiliary flute, and the auxiliary cutting edge has a length that extends between two adjacent auxiliary flutes of one set of auxiliary flutes measured along the first cutting edge, the length of the main cutting edge being greater than the length of the auxiliary cutting edge, and wherein a plane intersecting the first point of the main cutting edge positioned perpendicularly to the longitudinal axis aligns with at least the second point of the main cutting edge of each adjacent main flute or overlaps the main cutting edge of each adjacent main flute.

The present invention also provides a method of manufacturing the rotary tool disclosed herein, wherein the method comprises grinding the plurality of main flutes into the peripheral surface of the cutting section and grinding the plurality of auxiliary flutes into the peripheral surface of the cutting section.

The present invention further provides a method of milling a substrate using the rotary tool disclosed herein, the method comprising rotating the rotary tool in the direction of rotation and contacting a portion of the substrate with the rotating rotary tool.

These and other aspects of the present invention will be more apparent from the following description.

### BRIEF DESCRIPTION OF THE DRAWINGS

FIG. 1 is a perspective view of the rotary tool of the present invention.

FIG. 2 is a side view of the rotary tool of the present invention.

FIG. 3 is a view of the front end of the rotary tool of the present invention.

FIG. 4 is a sketch of the cutter profile for four main flutes as they rotate through a cut showing the alignment of the cutting edges of the rotary tool that make the cuts as each flute rotates through the substrate. The sketch shows the cutter profile for four consecutive main flutes.

### DETAILED DESCRIPTION

As stated above, the present invention is directed to a rotary tool having a longitudinal axis about which the rotary tool is rotatable in a direction of rotation, the rotary tool comprising: a base body extending in a longitudinal direction from a shank end to a front end opposite the shank end, the base body comprising a cutting section comprising a peripheral surface extending from the front end towards the shank end, the peripheral surface of the cutting section comprising: a plurality of main flutes extending helically about the longitudinal axis to define a plurality of helical teeth comprising a leading face, a rear face, and a first cutting edge facing the direction of rotation along the main flute, wherein each of the main flutes is between the rear face and leading face of two adjacent helical teeth, and a plurality of sets of auxiliary flutes, wherein the sets of auxiliary flutes comprise a first auxiliary flute closer along the longitudinal axis to the shank end and a final auxiliary flute closer along the longitudinal axis to the front end that each intersect a helical tooth to form a plurality of cutting units along the helical tooth comprising main cutting units and auxiliary cutting units, wherein the main cutting units comprise a main cutting edge along the first cutting edge of the helical tooth and a second cutting edge facing the direction of rotation along the auxiliary flute, wherein the main cutting edge has a length that extends between two sets of auxiliary flutes measured along the main flute from a first point defined as an intersection of the main flute and a final auxiliary flute and extending towards the front end to a second point defined as an intersection of the main flute and a first auxiliary flute, the second cutting edge has a length that extends between the main flutes measured along the auxiliary flute, and an aspect ratio of the length of the main cutting edge to the length of the second cutting edge is greater than 1:1, wherein the auxiliary cutting units comprise an auxiliary cutting edge along the first cutting edge of the helical tooth and a second cutting edge facing the direction of rotation along the auxiliary flute, wherein the auxiliary cutting edge has a length that extends between two adjacent auxiliary flutes of one set of auxiliary flutes measured along the first cutting edge, the second cutting edge has a length that extends between the main flutes measured along the auxiliary flute, and an aspect ratio of the length of the auxiliary cutting edge to the length of the second cutting edge is less than 1:1, and wherein the main cutting units alternate with one or more auxiliary cutting units along the helical tooth.

The present invention is also directed to a rotary tool having a longitudinal axis about which the rotary tool is rotatable in a direction of rotation, the rotary tool comprising: a base body extending in a longitudinal direction from a shank end to a front end opposite the shank end, the base body comprising a cutting section comprising a peripheral surface extending from the front end towards the shank end, the peripheral surface of the cutting section comprising: a plurality of main flutes extending helically about the longitudinal axis and a plurality of sets of auxiliary flutes that extend helically opposite hand from the main flutes about the longitudinal axis, wherein the sets of auxiliary flutes comprise a first auxiliary flute closer along the longitudinal axis to the shank end and a final auxiliary flute closer along the longitudinal axis to the front end that each intersect the main flutes to form a plurality of cutting units having a first cutting edge facing the direction of rotation along the main flute and a second cutting edge facing the direction of rotation along the auxiliary flute, wherein the first cutting edge of the cutting units formed along the main flute comprises a main cutting edge and an auxiliary cutting edge, wherein the main cutting edge has a length that extends between two sets of auxiliary flutes measured along the main flute from a first point defined as an intersection of the main flute and a final auxiliary flute and extending towards the front end to a second point defined as an intersection of the main flute and a first auxiliary flute, and the auxiliary cutting edge has a length that extends between two adjacent auxiliary flutes of one set of auxiliary flutes measured along the first cutting edge, the length of the main cutting edge being greater than the length of the auxiliary cutting edge, and wherein a plane intersecting the first point of the main cutting edge positioned perpendicularly to the longitudinal axis aligns with at least the second point of the main cutting edge of each adjacent main flute or overlaps the main cutting edge of each adjacent main flute.

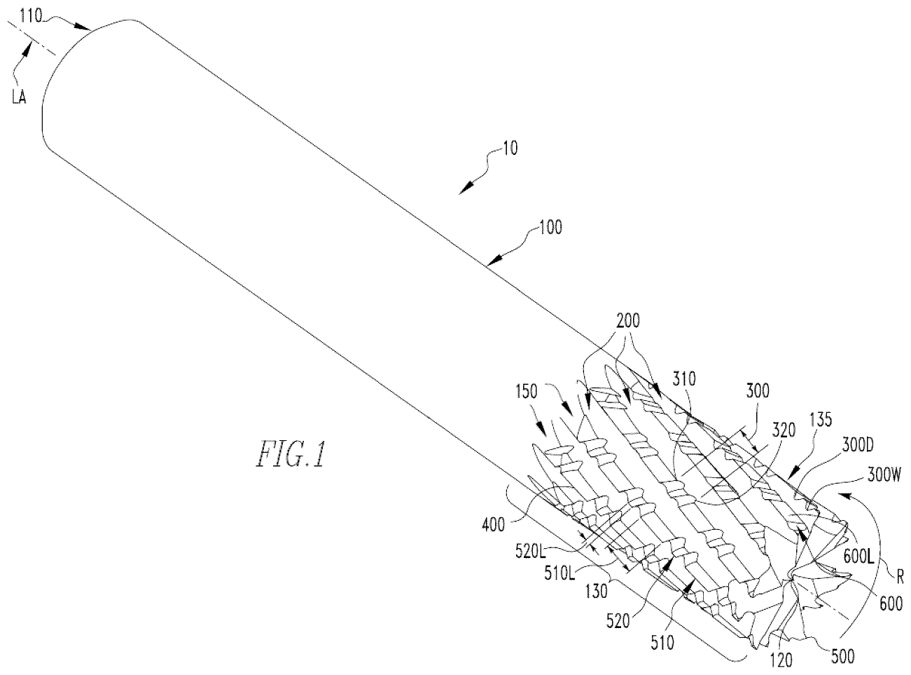

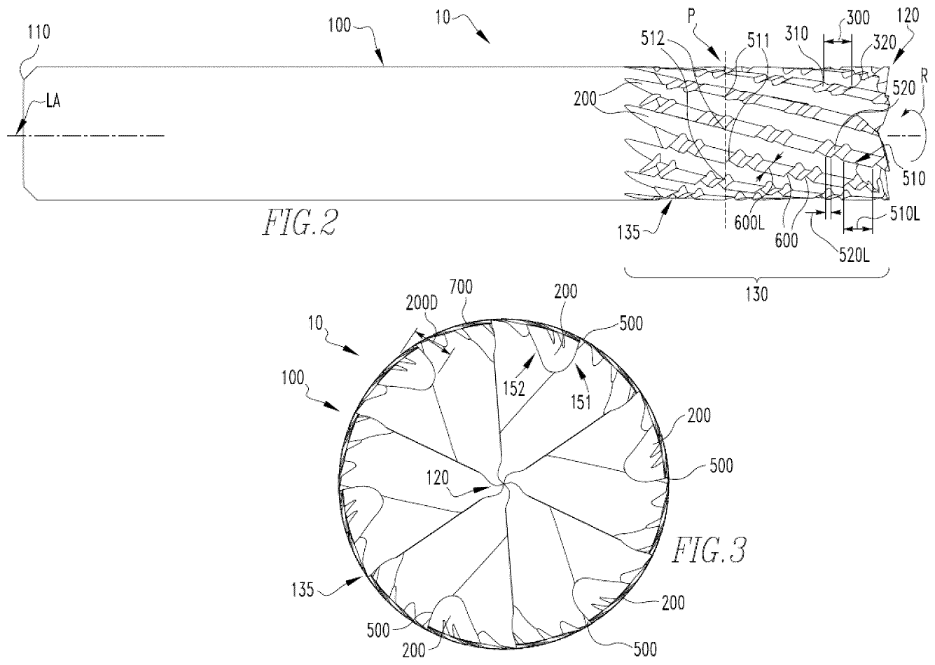

As shown in FIG. 1 and FIG. 2, the rotary tool 10 has a longitudinal axis (LA) about which the rotary tool 10 is rotatable in a direction of rotation (R). The direction of rotation (R) may be configured to be right-hand or left hand. The rotary tool 10 comprises a base body 100 extending in a longitudinal direction from a shank end 110 to a front end 120 opposite the shank end 110, the base body 100 comprising a cutting section 130 comprising a peripheral surface 135 extending from the front end 120 towards the shank end 110 along the longitudinal axis (LA). The peripheral surface 135 of the cutting section 130 comprises a plurality of helical main flutes 200 extending helically about the longitudinal axis (LA) and a plurality of sets of auxiliary flutes 300 that extend helically opposite hand from the main flutes 200 about the longitudinal axis (LA), wherein the sets of auxiliary flutes 300 comprise a first auxiliary flute 310 closer along the longitudinal axis (LA) to the shank end 110 and a final auxiliary flute 320 closer along the longitudinal axis (LA) to the front end 120 that each intersect the main flutes 200 to form a plurality of cutting units 400 having a first cutting edge 500 facing the direction of rotation (R) along the main flute 200 and a second cutting edge 600 facing the direction of rotation (R) along the auxiliary flute 300.

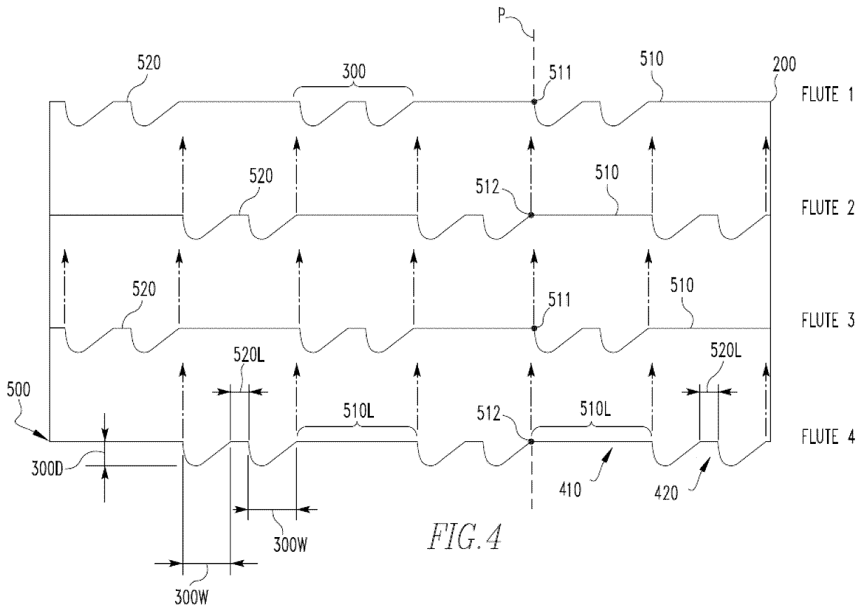

As shown in FIG. 1, the plurality of helical main flutes 200 extending helically about the longitudinal axis (LA) define a plurality of helical teeth 150 comprising a leading face 151, a rear face 152, and the first cutting edge 500 facing the direction of rotation (R) along the main flute 200. As shown in FIG. 1 and FIG. 3, each main flute 200 is positioned between the rear face 152 and the leading face 151 of two adjacent helical teeth 150. As shown in FIG. 1 and FIG. 4, each of the auxiliary flutes 300 intersects a helical tooth 150 to form a plurality of cutting units 400 along the helical tooth 150 comprising main cutting units 410 and auxiliary cutting units 420, wherein the main cutting units 410 comprise a main cutting edge 510 along the first cutting edge 500 of the helical tooth 150 and a second cutting edge 600 facing the direction of rotation (R) along the auxiliary flute 300.

As shown in FIG. 2, the first cutting edge 500 of the cutting units 400 formed along the main flute comprises a main cutting edge 510 (of the main cutting unis 410) and an auxiliary cutting edge 520 (of the auxiliary cutting units 420), wherein the main cutting edge 510 has a length 510L that extends between two sets of auxiliary flutes 300 measured along the main flute 200 from a first point 511 defined as an intersection of the main flute 200 and a final auxiliary flute 320 and extending towards the front end 120 to a second point 512 defined as an intersection of the main flute 200 and a first auxiliary flute 310, and the auxiliary cutting edge 520 has a length 520L that extends between two adjacent auxiliary flutes (e.g., a first auxiliary flute 310 and a final auxiliary flute 320 of a pair of auxiliary flutes 300) of one set of auxiliary flutes 300 measured along the first cutting edge 500, the length 510L of the main cutting edge 510 being greater than the length 520L of the auxiliary cutting edge 520, and wherein a plane (P) intersecting the first point 511 of the main cutting edge 510 positioned perpendicularly to the longitudinal axis (LA) aligns with at least the second point 512 of the main cutting edge 510 of each adjacent main flute 200.

As shown in FIG. 2, the second cutting edge 600 of the cutting units 400 formed along the auxiliary flute 300 has a length 600L that extends between the main flutes 200, and the aspect ratio of the length of the main cutting edge 510L to length of the second cutting edge 600L is greater than 1:1, such as at least 1.5:1, such as at least 2:1, such as at least 2.5:1, such as at least 3:1, such as at least 3.5:1, such as at least 4:1, such as at least 4.5:1, such as at least 5:1. Accordingly, the main cutting unit 410 may have an aspect ratio defined by the length of the main cutting edge 510L to the length of the second cutting edge 600L of greater than 1:1, such as at least 1.5:1, such as at least 2:1, such as at least 2.5:1, such as at least 3:1, such as at least 3.5:1, such as at least 4:1, such as at least 4.5:1, such as at least 5:1.

As shown in FIG. 2 and FIG. 4, the auxiliary cutting units comprise an auxiliary cutting edge 520 along the first cutting edge 500 of the helical tooth 150 and a second cutting edge 600 facing the direction of rotation (R) along the auxiliary flute 300, wherein the auxiliary cutting edge 520 has a length 520L that extends between two adjacent auxiliary flutes 300 of one set of auxiliary flutes 300 measured along the first cutting edge 500, the second cutting edge 600 has a length 600L that extends between the main flutes 200 measured along the auxiliary flute 300, and an aspect ratio of the length of the auxiliary cutting edge 520L to the length of the second cutting edge 600L is less than 1:1, such as less than 0.8:1, such as less than 0.7:1, such as less than 0.5:1, such as less than 0.4:1, such as less than 0.3:1. Accordingly, the auxiliary cutting unit 420 may have an aspect ratio defined by the length of the auxiliary cutting edge 520L to the length of the second cutting edge 600L of less than 1:1, such as less than 0.8:1, such as less than 0.7:1, such as less than 0.5:1, such as less than 0.4:1, such as less than 0.3:1.

As shown in FIG. 1, FIG. 2, and FIG. 4, the length of the main cutting edge 510 may be at least 3 times greater than the length of the auxiliary cutting edge 520, such as at least 3.5 times greater, such as at least 4 times greater, such as at least 4.5 times greater, such as at least 5 times greater.

As shown in FIG. 1, FIG. 2, and FIG. 4, the main cutting units 410 alternate with one or more auxiliary cutting units 420 along the helical tooth 150 along the longitudinal axis (LA). For example, the main cutting units 410 may alternative on a one-to-one basis with the auxiliary cutting units 420 along the helical tooth 150. Alternatively, the main cutting units 410 may alternative on a one-to-two basis with the auxiliary cutting units 420 along the helical tooth 150.

As shown in FIG. 1 and FIG. 2, the set of auxiliary flutes 300 may comprise two auxiliary flutes corresponding to a first auxiliary flute 310 and a final auxiliary flute 320. Alternatively, the set of auxiliary flutes 300 may comprise three auxiliary flutes, four auxiliary flutes, or more. A set of auxiliary flutes 300 comprising three auxiliary flutes corresponds to a first auxiliary flute 310, a second auxiliary flute (not shown), and a final auxiliary flute 320. Additionally, the set of auxiliary flutes 300 may vary from set-to-set. For example, a first set of auxiliary flutes 300 may comprise two auxiliary flutes and a second set of auxiliary flutes 300 may comprise three auxiliary flutes. As shown in FIG. 1 and FIG. 2, when the set of auxiliary flutes 300 comprises two auxiliary flutes corresponding to a first auxiliary flute 310 and a final auxiliary flute 320, the first cutting edge 500 comprises alternating main cutting edges 510 and auxiliary cutting edges 520 along the length of the main flute 200.

The main flutes 200 and/or helical teeth 150 may have a spiral angle of 10° to 25°, such as 15° to 20° and the auxiliary flutes 300 may have a spiral angle of 35° to 55°, such as 40° to 50°. All of the main flutes 200 and/or helical teeth 150 may have a uniform spiral angle. All of the auxiliary flutes 300 may have a uniform spiral angle.

As shown in FIG. 1 and FIG. 2, the main flutes 200 and auxiliary flutes have opposite hand orientation about the longitudinal axis (LA) relative to each other. For example, the main flutes 200 may be right-hand helical flutes and the auxiliary flutes 300 may be left hand helical flutes. The main flutes 200 are oriented facing the direction of rotation (R) of the rotary tool 10.

As shown in FIG. 1 and FIG. 2, the width of the auxiliary flutes 300W measured along the main flute 200 may be equal for each auxiliary flute 300.

The auxiliary flutes 300 may have a depth 300D that is less than a depth 200D of the main flutes 200.

The radial distance from the longitudinal axis (LA) of the second cutting edge 600 may decrease as the second cutting edge 600 extends away from the first cutting edge 500.

As shown in FIG. 2, a plane (P) intersecting the first point 511 of the main cutting edge 510 positioned perpendicularly to the longitudinal axis (LA) aligns with at least the second point 512 of the main cutting edge 510 of each adjacent main flute 200. Alternatively, the main cutting edge 510 positioned perpendicularly to the longitudinal axis (LA) may overlap the main cutting edge 510 of each adjacent main flute 200 so long as there is no gap created such that a substrate to be cut would not be cut by the main cutting edge 510 of two successive main flutes 200.

FIG. 4 provides further illustration of the cutting profile of the rotary tool 10. The figure shows the cutter profile of four successive main flutes 200 that include alternating main cutting edges 510 and auxiliary cutting edges 520 that would contact the substrate to be cut. FIG. 4 illustrates that the cutting profile will result in the substrate to be cut being cut by at least one main cutting edge 510 with every other main flute 200 that rotates through the cut. This geometry prevents accumulated chip load resulting from edges that are not aligned and do not overlap resulting in three, four, or more main flutes rotating through the cut without cutting the substrate and resulting in a larger localized chip load that provides additional stress to the cutting edge that can result in damage to the cutting edge.

At least a portion of the peripheral surface 135 of the cutting section 130 may comprise a coating 700. The coating 700 may comprise a diamond coating applied by any appropriate method, such as, for example, chemical vapor deposition (CVD). The coating 700 may have a thickness of 5 to 20 microns.

The rotary tool may be a burr router.

The present disclosure is also directed to a method of manufacturing the rotary tool disclosed herein, wherein the method comprises grinding the plurality of main flutes into the peripheral surface of the cutting section and grinding the plurality of auxiliary flutes into the peripheral surface of the cutting section. The method may further comprise applying a coating by CVD to at least a portion of the peripheral surface of the cutting section such that at least a portion of the peripheral surface of the cutting section comprises such coating. The coating may be a diamond coating.

The present disclosure is also directed to a method of milling a substrate using the rotary tool disclosed herein, the method comprising rotating the rotary tool in the direction of rotation and contacting a portion of the substrate with the rotating rotary tool. The substrate may comprise a carbon fiber reinforced polymer substrate.

As used herein, “including,” “containing” and like terms are understood in the context of this application to be synonymous with “comprising” and are therefore open-ended and do not exclude the presence of additional undescribed or unrecited elements, materials, phases or method steps. Nevertheless, they also include the more restrictive terms “consisting of” and “consisting essentially of”. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

1. A rotary tool having a longitudinal axis about which the rotary tool is rotatable in a direction of rotation, the rotary tool comprising:
a base body extending in a longitudinal direction from a shank end to a front end opposite the shank end, the base body comprising a cutting section comprising a peripheral surface extending from the front end towards the shank end, the peripheral surface of the cutting section comprising:
a plurality of main flutes extending helically about the longitudinal axis to define a plurality of helical teeth comprising a leading face, a rear face, and a first cutting edge facing the direction of rotation along the main flute, wherein each of the main flutes is between the rear face and leading face of two adjacent helical teeth, and
a plurality of sets of auxiliary flutes, wherein the sets of auxiliary flutes comprise a first auxiliary flute closer along the longitudinal axis to the shank end and a final auxiliary flute closer along the longitudinal axis to the front end that each intersect a helical tooth to form a plurality of cutting units along the helical tooth comprising main cutting units and auxiliary cutting units,
wherein the main cutting units comprise a main cutting edge along the first cutting edge of the helical tooth and a second cutting edge facing the direction of rotation along the auxiliary flute, wherein the main cutting edge has a length that extends between two sets of auxiliary flutes measured along the main flute from a first point defined as an intersection of the main flute and a final auxiliary flute and extending towards the front end to a second point defined as an intersection of the main flute and a first auxiliary flute, the second cutting edge has a length that extends between the main flutes measured along the auxiliary flute, and an aspect ratio of the length of the main cutting edge to the second cutting edge is greater than 1:1,
wherein the auxiliary cutting units comprise an auxiliary cutting edge along the first cutting edge of the helical tooth and a second cutting edge facing the direction of rotation along the auxiliary flute, wherein the auxiliary cutting edge has a length that extends between two adjacent auxiliary flutes of one set of auxiliary flutes measured along the first cutting edge, the second cutting edge has a length that extends between the main flutes measured along the auxiliary flute, and an aspect ratio of the length of the auxiliary cutting edge to the second cutting edge is less than 1:1, and
wherein the main cutting units alternate with one or more auxiliary cutting units along the helical tooth.

2. The rotary tool of claim 1, wherein a plane intersecting the first point of the main cutting edge positioned perpendicularly to the longitudinal axis aligns with at least the second point of the main cutting edge of each adjacent main flute or overlaps the main cutting edge of each adjacent main flute.

3. The rotary tool of claim 1, wherein the set of auxiliary flutes comprise two auxiliary flutes and the first cutting edge comprises alternating main cutting edges and auxiliary cutting edges.

4. The rotary tool of claim 1, wherein the set of auxiliary flutes comprise more than two auxiliary flutes.

5. The rotary tool of claim 1, wherein the main flutes have a spiral angle of 10° to 25° and the auxiliary flutes having a spiral angle of 35° to 55°.

6. The rotary tool of claim 1, wherein the main flutes are right hand helical flutes and the auxiliary flutes are left hand helical flutes.

7. The rotary tool of claim 1, wherein each auxiliary flute has an equal width measured along the main flute.

8. The rotary tool of claim 1, wherein the auxiliary flutes have a depth that is less than a depth of the main flutes.

9. The rotary tool of claim 1, wherein the radial distance from the longitudinal axis of the second cutting edge decreases as the second cutting edge extends away from the first cutting edge.

10. The rotary tool of claim 1, wherein the length of the main cutting edge is at least 3 times greater than the length of the auxiliary cutting edge.

11. The rotary tool of claim 1, wherein at least a portion of the peripheral surface of the cutting section comprises a coating.

12. The rotary tool of claim 11, wherein the coating comprises a diamond coating having a coating thickness of 5 to 20 microns.

13. The rotary tool of claim 11, wherein the coating comprises a diamond coating applied by CVD.

14. A method of manufacturing the rotary tool of claim 1, wherein the method comprises grinding the plurality of main flutes into the peripheral surface of the cutting section and grinding the plurality of auxiliary flutes into the peripheral surface of the cutting section.

15. The method of claim 14, wherein at least a portion of the peripheral surface of the cutting section comprises a coating and the method further comprises applying the coating by CVD.

16. A method of milling a substrate using the rotary tool of claim 1, the method comprising rotating the rotary tool in the direction of rotation and contacting a portion of the substrate with the rotating rotary tool.

17. The method of claim 16, wherein the substrate comprises a carbon fiber reinforced polymer substrate.

18. A rotary tool having a longitudinal axis about which the rotary tool is rotatable in a direction of rotation, the rotary tool comprising:
a base body extending in a longitudinal direction from a shank end to a front end opposite the shank end, the base body comprising a cutting section comprising a peripheral surface extending from the front end towards the shank end, the peripheral surface of the cutting section comprising:
a plurality of main flutes extending helically about the longitudinal axis and a plurality of sets of auxiliary flutes that extend helically opposite hand from the main flutes about the longitudinal axis, wherein the sets of auxiliary flutes comprise a first auxiliary flute closer along the longitudinal axis to the shank end and a final auxiliary flute closer along the longitudinal axis to the front end that each intersect the main flutes to form a plurality of cutting units having a first cutting edge facing the direction of rotation along the main flute and a second cutting edge facing the direction of rotation along the auxiliary flute,
wherein the first cutting edge of the cutting units formed along the main flute comprises a main cutting edge and an auxiliary cutting edge, wherein the main cutting edge has a length that extends between two sets of auxiliary flutes measured along the main flute from a first point defined as an intersection of the main flute and a final auxiliary flute and extending towards the front end to a second point defined as an intersection of the main flute and a first auxiliary flute, and the auxiliary cutting edge has a length that extends between two adjacent auxiliary flutes of one set of auxiliary flutes measured along the first cutting edge, the length of the main cutting edge being greater than the length of the auxiliary cutting edge, and
wherein a plane intersecting the first point of the main cutting edge positioned perpendicularly to the longitudinal axis aligns with at least the second point of the main cutting edge of each adjacent main flute or overlaps the main cutting edge of each adjacent main flute.

19. The rotary tool of claim 18, wherein the axis formed perpendicularly to the longitudinal axis that intersects the first point of the main cutting edge aligns with the second point of the main cutting edge of each adjacent main flute.

20. The rotary tool of claim 18, wherein the second cutting edge of the cutting units formed along the auxiliary flute has a length that extends between the main flutes, and the aspect ratio of the main cutting edge to second cutting edge is at least 1.5:1.
